(19) United States
(12) Patent Application Publication
(10) Pub. No.: US 2016/0339538 A1
(43) Pub. Date: Nov. 24, 2016

(54) HIGH TEMPERATURE BONDING PROCESSES INCORPORATING TRACES

(71) Applicant: Toyota Motor Engineering & Manufacturing North America, Inc., Erlanger, KY (US)

(72) Inventors: Shailesh N. Joshi, Ann Arbor, MI (US); Masao Noguchi, Ann Arbor, MI (US)

(73) Assignee: Toyota Motor Engineering & Manufacturing North America, Inc., Erlanger, KY (US)

(21) Appl. No.: 14/714,425

(22) Filed: May 18, 2015

(51) Int. Cl. B23K 20/02; B23K 1/00; B23K 35/26; B23K 35/02; B32B 15/01; C22C 13/00

(52) U.S. Cl. CPC B23K 20/026; B32B 15/01; C22C 13/00; B23K 35/262; B23K 35/0233; B23K 35/0244; B23K 1/00

(57) ABSTRACT

A method for high temperature bonding of substrates may include providing first and second substrates and forming at least one trace onto one or more adjacent surfaces of the substrates. The trace may include at least a first configuration of a material having a high melting temperature. The material may include at least one or more chemical elements selected from a group consisting of nickel, silver, aluminum, and copper. The method may further include depositing tin on a top surface of the trace and bonding the substrates together to create a bond layer using a high temperature bonding process. The top surface of the trace may be disposable between the substrates. The trace may be incorporated into the bond layer that is dispersed between aligned and adjacent surfaces of the substrates. The first configuration may form one or more intermetallic bonds in the bond layer.

### TECHNICAL FIELD

The present specification generally relates to methods for high temperature bonding and substrates formed therefrom and, more specifically, methods for high temperature bonding applying high temperature bonding processes incorporating formed traces to one or more surfaces of at least a pair of substrates to form a strengthened bond layer between a pair of substrates.

### BACKGROUND

Power semiconductor devices, such as those fabricated from SiC (silicon carbide), may be designed to operate at very high operating temperatures (e.g., greater than 250° C). Such power semiconductor devices may be bonded to a cooling device, such as a heat sink or a liquid cooling assembly, for example. The cooling device removes heat from the power semiconductor device to ensure that it operates at a temperature that is below its maximum operating temperature. The bonding layer that bonds the power semiconductor device to the cooling device must be able to withstand the high operating temperatures of the power semiconductor device.

Transient liquid phase (TLP) or diffusion bonding or soldering are methods of high temperature bonding that may be applied. For example, TLP bonding results in a bond layer having a high temperature melting point. A typical TLP bond consists of two different material compounds: a metallic layer and an intermetallic layer or alloy. Generally, the intermetallic layer is formed during an initial melting phase wherein a low melting temperature material, such as tin, diffuses into high melting temperature materials, such as copper or nickel. While the intermetallic alloy has a high re-melting temperature in conventional high temperature bonding processes, a stronger bond layer would result in a stronger bonded substrate

Accordingly, a need exists for alternative methods for high temperature bonding of substrates for forming a strengthened bonding layer between a pair of substrates.

### SUMMARY

In one embodiment, a method for high temperature bonding of substrates includes providing a first substrate and a second substrate and forming at least one trace onto one or more adjacent surfaces of the first and second substrates. The at least one trace includes at least a first configuration of a material having a high melting temperature. The material includes at least one or more chemical elements selected from a group consisting of nickel, silver, aluminum, and copper. The method further includes depositing at least a first amount of tin on a top surface of the at least one trace and bonding the first and second substrates together to create a bond layer using a high temperature bonding process. The top surface of the at least one trace is disposable between and facing at least one of the first substrate and the second substrate. The at least one trace is incorporated into the bond layer that is dispersed between aligned and adjacent surfaces of the first and second substrates. The first configuration forms one or more intermetallic bonds in the bond layer.

In another embodiment, a bonding assembly includes a first bonding assembly including a first substrate and a second substrate and at least one trace formable onto one or more adjacent surfaces of the first and second substrates. Each of the first substrate and the second substrate includes at least one or more chemical elements selected from a group consisting of nickel, silver, aluminum, and copper. The at least one trace includes at least a first configuration of a material having a high melting temperature. The material includes at least one or more chemical elements selected from a group consisting of nickel, silver ink, and copper. The bonding assembly further includes at least a first amount of tin depositable on a top surface of the at least one trace. The top surface is disposable between and facing at least one of the first substrate and the second substrate prior to bonding, and the at least one trace is incorporated into a bond layer after using a high temperature bonding process. The high temperature bonding process includes one of transient liquid phase soldering or a diffusion soldering. The bond layer bonds the first and second substrates together and be dispersed between aligned and adjacent surfaces of the first and second substrates. The first configuration forms one or more intermetallic bonds in the bond layer.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is allow chart of a process for high temperature bonding of substrates by forming at least a first configuration of at least one trace that is incorporated into a bond layer between a pair of substrates after high temperature bonding according to one or more embodiments shown and described herein;

FIG. 2A schematically depicts an exemplary bonding assembly prior to bonding of a pair of substrates and including two traces forming a first configuration on a surface of a bottom substrate, and a tin coating deposited on top surfaces of the traces, according to one or more embodiments shown and described herein;

FIG. 2B schematically depicts the bonding assembly of FIG. 2A with a tin coating alternatively deposited over top surfaces of the traces and the bottom substrate according to one or more embodiments shown and described herein;

FIG. 3A schematically depicts another exemplary bonding assembly prior to bonding of a pair of substrates and including two traces forming a first configuration on a surface of a top substrate and two traces forming an aligned second configuration on a surface of a bottom substrate according to one or more embodiments shown and described herein;

FIG. 3B schematically depicts the bonding assembly of FIG. 3A with a tin coating deposited between top surfaces of the traces according to one or more embodiments shown and described herein;

FIG. 3C schematically depicts the bonding assembly of FIG. 3A with a tin coating alternatively deposited between top surfaces of the traces and adjacent surfaces of the substrates according to one or more embodiments shown and described herein;

FIG. 4A schematically depicts yet another exemplary bonding assembly prior to bonding of a pair of substrates and including a trace forming a first configuration on a surface of a top substrate and two traces forming a second configuration on a surface of a bottom substrate according to one or more embodiments shown and described herein;

FIG. 4B schematically depicts the bonding assembly of FIG. 4A with a tin coating deposited on and between top surfaces of the traces according to one or more embodiments shown and described herein;

FIG. 4C schematically depicts the bonding assembly of FIG. 4A with a tin coating deposited on the top surface of the trace of the first configuration on the top substrate and on a bottom-substrate facing surface of the top substrate and alternatively deposited on the top surfaces of the traces of the second configuration according to one or more embodiments shown and described herein;

FIG. 5 schematically depicts an exemplary bonding assembly that includes a bond layer after the bonding of a pair of substrates;

FIG. 6 schematically depicts a top plan view of an exemplary bonding assembly prior to bonding of a pair of substrates that includes traces forming a square configuration and a circular configuration on at least one of adjacent-facing surfaces of a bottom substrate or a top substrate according to one or more embodiments shown and described herein;

FIG. 7 schematically depicts a top plan view of an exemplary bonding assembly prior to bonding of a pair of substrates that includes traces forming double nested hexagonal configurations on at least one of adjacent-facing surfaces of a bottom substrate or a top substrate according to one or more embodiments shown and described herein;

FIG. 8 schematically depicts a top plan view of an exemplary bonding assembly prior to bonding of a pair of substrates that includes traces forming a radial configuration on at least one of adjacent-facing surfaces of a bottom substrate or a top substrate according to one or more embodiments shown and described herein;

FIG. 9 schematically depicts a top plan view of an exemplary bonding assembly prior to bonding of a pair of substrates that includes traces forming a set of configurations or patterns on at least one of adjacent-facing surfaces of a bottom substrate or a top substrate according to one or more embodiments shown and described herein; and

FIG. 10 schematically depicts a top plan view of an exemplary bonding assembly prior to bonding of a pair of substrates that includes traces forming a spiral configuration on at least one of adjacent-facing surfaces of a bottom substrate or a top substrate according to one or more embodiments shown and described herein.

### DETAILED DESCRIPTION

Referring generally to the figures, embodiments of the present disclosure are directed to methods for high temperature bonding of substrates and substrates formed therefrom. The methods include providing a pair of substrates and forming one or more nickel, copper, aluminum, and/or silver traces in at least a first configuration, shape, or pattern onto one or more adjacent surfaces of the substrates. The traces may be made of like metal materials such as magnetic metals. The methods further include depositing tin atop at least one trace of the one or more traces, and bonding the substrates together to create a bond layer that incorporates the one or more traces. In aspects, forming the at least one trace may include printing a configuration of the trace or traces directly onto one or more adjacent surfaces of the substrates. The printing may be done via three-dimensional printing. Forming and adding a three-dimensional trace shape to a substrate surface increases the surface area of a metal material having a high melting temperature (such as nickel, copper, aluminum, and/or silver). This metal material may bond with a low melting temperature material such as tin to form intermetallic alloys during a high temperature bonding process such as transient liquid phase or diffusion soldering, The additional surface area provided by the metal material allows for a stronger bond layer including a greater amount of intermetallic alloys to form during a high temperature bonding process between the bonded substrates.

Various embodiments of methods for high temperature bonding of substrates and substrates formed therefrom are described in detail herein. Although exemplary methods for high temperature bonding of substrates are described in the context of power electronics applications (e.g., to bond a power semiconductor device to a cooling assembly in an inverter circuit of hybrid or electric vehicles), the use of methods described herein is not limited thereto. For example, exemplary methods and substrates funned therefrom that are described herein may be implemented in other semiconductor use applications and other applications to bond two components together.

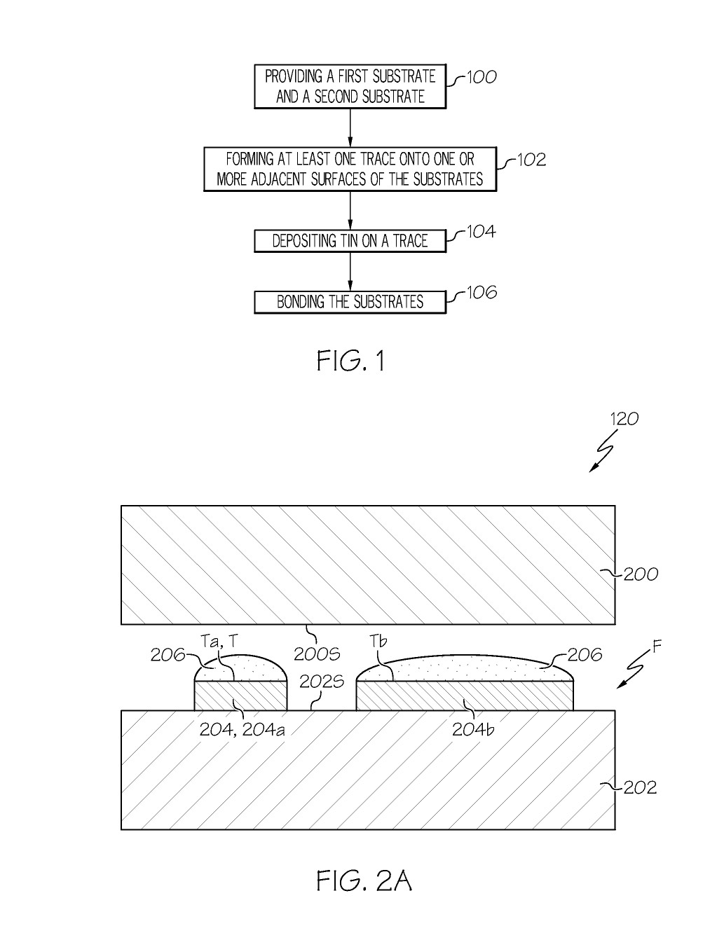

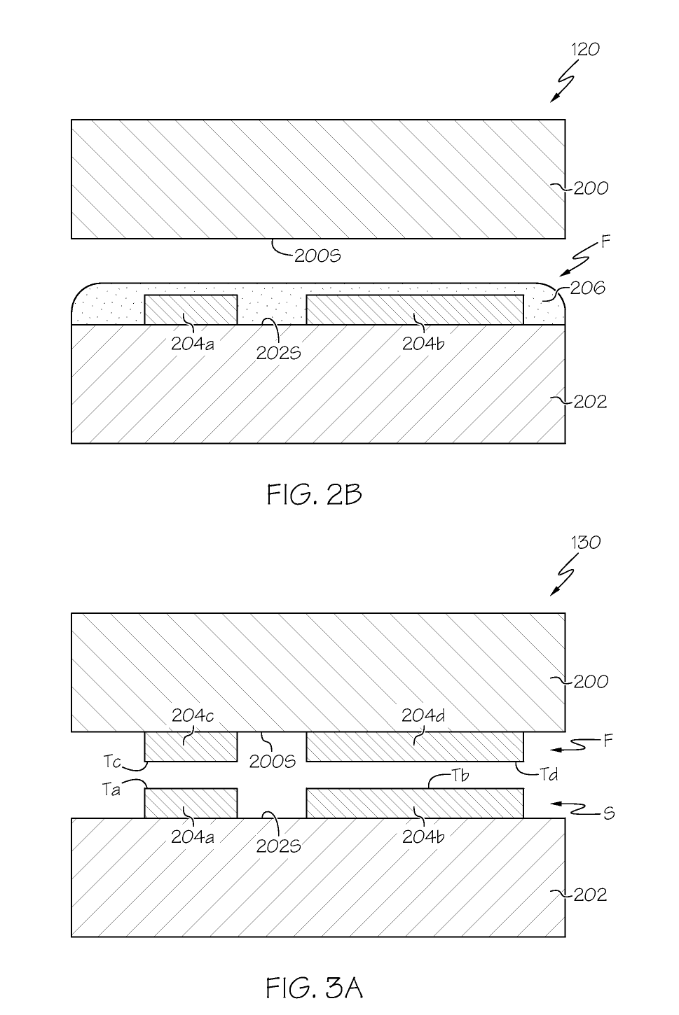

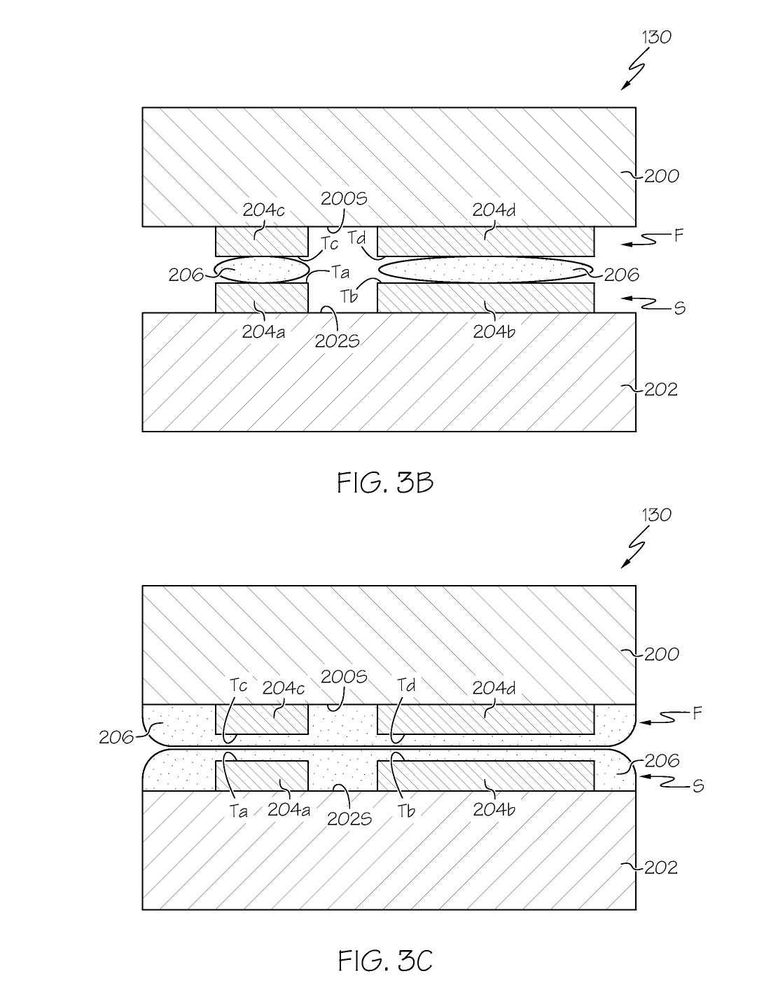

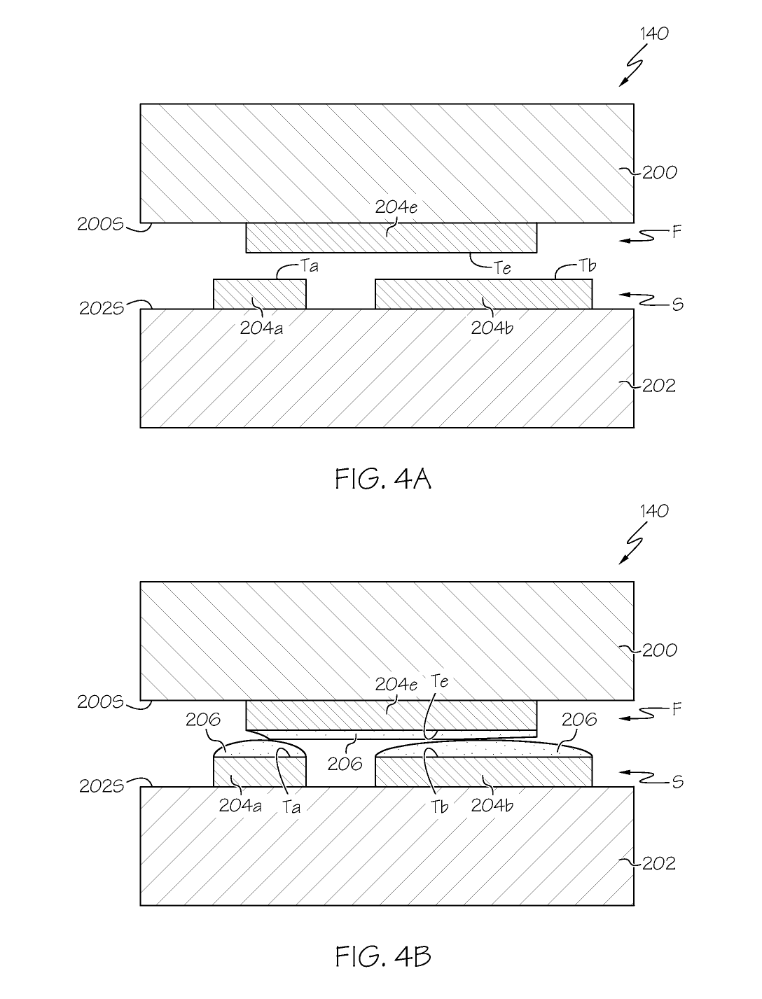

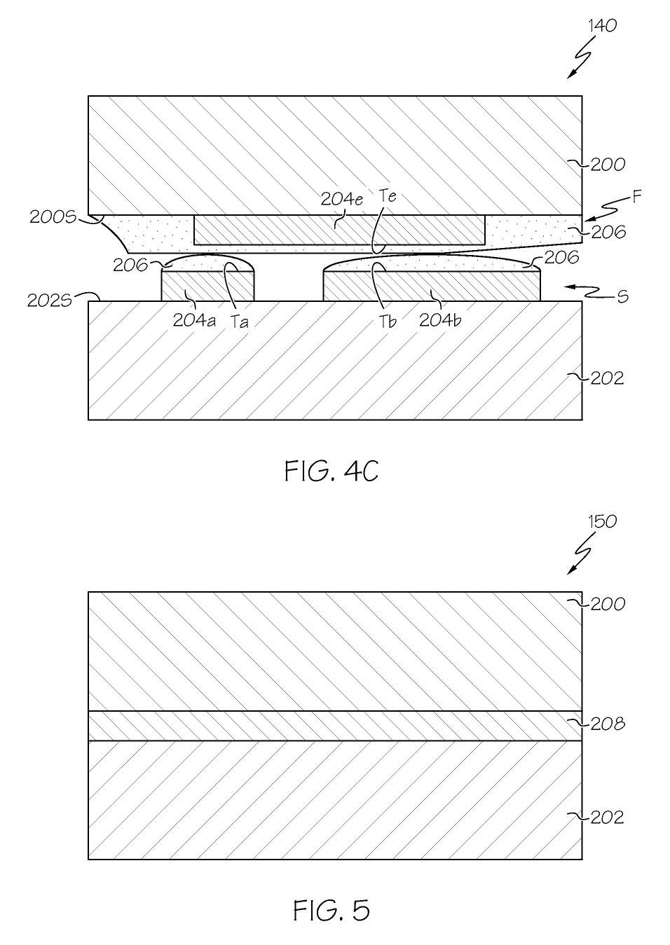

FIG. 1 depicts an exemplary method that is described herein and further below mostly with reference to bonding assembly 120 of FIGS. 2A-2B for exemplary and explanatory purposes. The method of FIG. 1, however, is applicable to any of bonding assemblies 130 and 140 of respective FIGS. 3A-3C and FIGS. 4A-4C to form the bonded assembly 150 of FIG. 5.

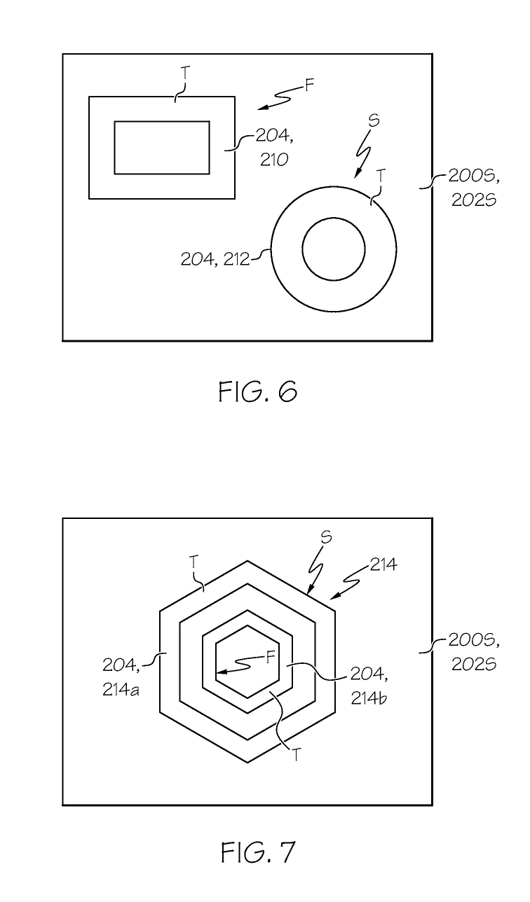

Recited herein is an exemplary summarization regarding FIGS. 2A-10, each of which will be described in greater detail further below. FIGS. 2A-2B depict a bonding assembly 120 having a first configuration F. FIG. 2A depicts a first tin coating option, and a FIG. 2B depicts a second tin coating option. FIGS. 3A-3C depict bonding assembly 130 having first configuration F and second configuration S (FIG. 3A), a first tin coating option (FIG. 3B), and an alternative second tin coating option (3C). And FIGS. 4A-4C depict bonding assembly 140 having first configuration F and second configuration S (F(G. 4A), a first tin coating option (FIG. 4B), and an alternative second tin coating option (4C). FIG. 5 depicts the bonded assembly 150. FIGS. 6-10 depict one or more trace configurations, shapes, or patterns that may be used with any of the bonding assemblies described herein.

Referring once again to FIG. 1, a flow chart shows an exemplary process for high temperature bonding of substrates, such as substrates 200 and 202 of exemplary bonding assemblies 120, 130, 140, and 150 of FIGS. 2A-5. The flow chart of FIG. 1 depicts forming at least a first configuration F, as shown in FIG. 2A, of at least one trace 204, such as traces 204a or 204b in FIG. 2A. An at least one trace 204a and/or 204b is incorporated into a bond layer, such as bond layer 108 shown in FIG. 5, that is disposed between a pair of substrates 200 and 202 after high temperature bonding according to one or more embodiments shown and described herein.

Referring to FIGS. 1 and 2A, in a block 100, a first substrate 200 and a second substrate 202 is provided. For example, the first substrate 200 may be a top substrate 200 in comparison to the second, bottom substrate 202. The first substrate 200 may include a die that is made of Si (silicon) or SiC (silicon carbide) or like materials. The second substrate 202 may be made of a direct bonded metal such as direct bonded copper, direct bonded aluminum, and/or like materials. Both substrates 200 and 202 may include respective adjacent-facing surfaces 200S and 202S that include at least one of copper (Cu), nickel (Ni), and/or silver (Ag). In some embodiments, both substrates 200 and 202 and respective surfaces 2005 and 202S may include at least one of nickel, silver ink, and/or copper.

In block 102 of FIG. 1, and as shown in FIG. 2A, at least one trace 204 (such as traces 204a and 204b) may be formed onto one or more adjacent surfaces 200S and 202S of the respective first and second substrates 200 and 202. The at least one trace 204 includes at least a first configuration F of a material having a high melting temperature. For example, the high melting temperature is above a low melting temperature associated with tin, as will be described further below. The material of the trace 204 includes at least one of nickel, silver, alumninum, and/or copper. For example, traces 204a and 204b of FIG. 2A may be copper traces forming a first configuration F. Alternatively, the trace 204a may be a copper trace, and the trace 204b may be a nickel trace.

In some embodiments, the trace 204 may be formed by printing the first configuration F of trace 204 directly onto the one or more adjacent surfaces 200S and 202S of respective first and second substrates 200 and 202. For example, referring to FIG. 2A, traces 204a and 204b may be formed by printing the first configuration F of the traces 204a and 204b directly onto the surface 202S of the second substrate 202. In some embodiments, the printing may include utilizing a three-dimensional (3D) printing process, such as those commercially available through PBC Linear of Roscoe, Ill., USA, for example. In other embodiments, the trace 204 may be formed by etching the at least first configuration F of the trace 204 onto the one or more surfaces 200S and 202S of respective first and second substrates 200 and 202. For example, the first configuration F of traces 204a and 204b of FIG. 2A may be etched onto the surface 202S of the second substrate 202. In aspects, the first and/or second substrates 200 and/or 202 may be configured as direct bonded copper substrates. For example, in FIG. 2A, second substrate 202 may be a direct bonded copper substrate.

In some embodiments, the trace 204 may be formed as set forth in a block 102 of FIG. 1. The trace 204 may be deposited onto one or more adjacent surfaces 200S and 202S of respective first and second substrates 200 and 202. In further aspects, as shown in FIGS, 3A-4C that will be described in greater detail further below, traces 204 form a first configuration IF on the first substrate surface 200S of the first substrate 200. Traces 204 form a second configuration S on the second substrate surface 202S of the second substrate 202. The second configuration S may include a second configuration material having a high melting temperature. And the second configuration material may include at least one of nickel, silver, or copper.

In a block 104 of FIG. 1, and referring again to FIG. 2A, at least first amount of tin (Sn) 206 is deposited on a top surface T of the trace 204. In embodiments, tin 206 has a low melting temperature that is less than the high melting temperature of the material of the trace 204 such that, when a high temperature bonding process is applied, the tin will melt to form a solder that will then interact with the trace 204. The interaction will form one or more intermetallic bonds, as further described below with respect to a block 106 of FIG. I. Referring to FIG. 2A, the top surface T of the trace 204 is disposable between and faces or is facing at least one of substrates 200 and 202. For example, the top surfaces Ta and Tb of respective traces 204a and 204b are disposable between substrates 200 and 202 and face the surface 200S of the substrate 200.

In some embodiments, the material of the at least one trace 204 includes a weight percent of 30% and the tin (Sit) 206 comprises a weight percent of 70%. In embodiments, the material of the at least one trace 204 may comprise at least about 30 wt % copper, at least about 30 wt % nickel, at least about 30 wt % aluminum, and/or at least 30 wt % silver. In other embodiments, the material of the at least one trace 204 includes a weight percent of in the range of from about 20% to about 40% and the tin (Sn) 206 comprises a respective weight percent in the range of from about 80% to about 60%. In embodiments, the material of the at least one trace 204 may comprise at least about 20 wt % copper, at least about 25 wt % copper, at least about 30 wt % copper, at least about 35 wt % copper, at least about 40 wt % copper, about 20 wt % aluminum, at least about 25 wt % aluminum, at least about 30 wt % aluminum, at least about 35 wt % aluminum, at least about 40 wt % aluminum, at least about 20 wt % nickel, at least about 25 wt % nickel, at least about 30 wt % nickel, at least about 35 wt % nickel, at least about 40 wt % nickel, at least about 20 wt % silver, at least about 25 wt % silver, at least about 30 wt % silver, at least about 35 wt % silver, and/or at least about 40 wt % silver. For example, the amount of Sn may include a weight percent of 60% Sn, and the amount of the plurality of metal particles may include a weight percent of 40% Ni. Or the amount of Sn may include a weight percent of 60% Sn, and the amount of the plurality of metal particles may include a weight percent of 40% Cu. Or the amount of Sn may include a weight percent of 80% Sn, and the amount of the plurality of metal particles may include a weight percent of 20% Ag. 100351 In embodiments, the tin 206 is deposited on the top surface T of the trace 204 as shown in block 104 of FIG. I and exemplary bonding assembly 120 of FIG. 2A. The tin 206 is coated onto the top surface T by being applied via foils made of tin and/or via a powder including tin in its composition and/or an organic binder such as paste including tin in its composition. In some embodiments, the tin 206 may be deposited on the top surface T of the trace 204 by being deposited as a mesh tin pattern. In other embodiments, the method of FIG. 1 may include the at least a first amount of the tin (Su) 206 being deposited onto one or more adjacent surfaces 200S and 2025 of respective substrates 200 and 202, such as shown in FIGS. 2B, 3C, and 4C. In a non-limiting example, the tin 206 may be deposited via at least one of coating with tin, applying foils including tin, or applying powder including tin,

In embodiments, and as shown in FIGS. 3A-3C, the first configuration F of the first substrate 200 is substantially aligned with, matching with, and disposed above the second configuration S of the second substrate 202. In some embodiments, the tin 206 is disposed between top surfaces T of the first configuration F and the second configuration S. For example, the tin 206 may be disposed between aligned top surfaces T of first and second configurations F and S as shown in FIGS. 3B-3C. As another example, the tin 206 may be disposed between aligned top surfaces T of first and second configurations F and S and spaced away from surfaces 200S and 202S of first and second substrates 200 and 202 as shown in FIGS. 3B.

Referring to block 104 of FIG. 1 and FIGS. 3B-3C and 4B-4C, in some embodiments, tin 206 may be deposited on the top surface T of the first configuration F and a top surface T of the second configuration S such that the tin 206 is disposed between the first and second substrates 200 and 202. The top surface T of the first configuration F faces the second substrate 202, and the top surface T of the second configuration S faces the first substrate 200. For example, in FIG. 3B, top surfaces Te and Td of the first configuration F of the first substrate 200 faces top surfaces Ta and Tb of the second configuration S of the second substrate 202. As another non-limiting example, FIG. 3B shows the tin 206 deposited between traces 204a and 204c and between traces 204b and 204d of respective second and first configurations S and F. In FIG. 3B, the tin 206 is spaced away from adjacent surfaces 200S and 202S. Alternatively, FIG. 3C shows an example in which the tin 206 is deposited between substrates 200 and 202 and covers top surfaces Ta-Td of respective traces 204a-204d as well as adjacent facing surfaces 200S and 202S of respective substrates 200 and 202 such that the tin 206 fully covers first and second configurations F and S. As a further non-limiting example, FIG. 4B shows portions of the tin 206 deposited between traces 204a and 204e as well as traces 204b and 204e to cover first and second configurations F and S of respective substrates 200 and 202. In FIG, 4B, the tin 206 is spaced away from adjacent surfaces 200S and 202S. Alternatively, FIG. 4C shows an example in which tin 206 is deposited between substrates 200 and 202 and covers top surfaces Ta, Tb, and Te of respective traces 204a, 204b, and 204e as well as the surface 200S of the first substrate 200.

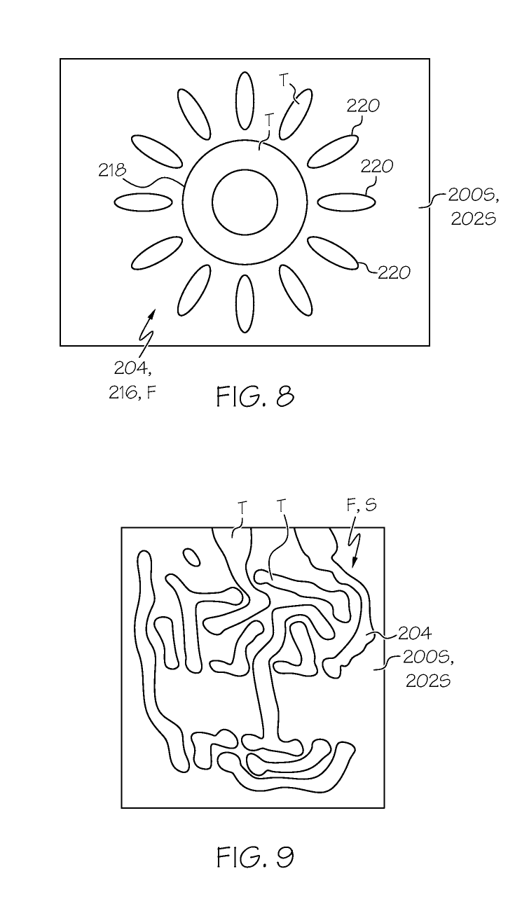

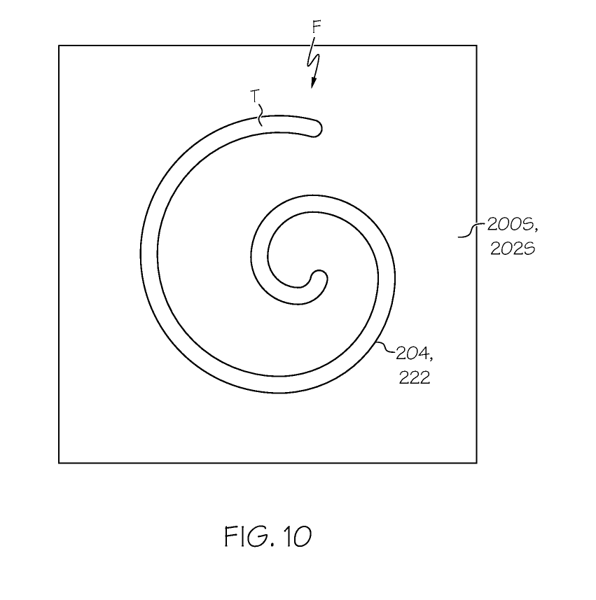

In embodiments, and as shown in FIGS. 6-10, the first configuration F and/or the second configuration S may include a variety of configurations, patterns or shapes. For example, the surface 200S of the first substrate 200 and/or the surface 202S of the second substrate 202 may include at least one of a first configuration F or a second configuration S. As shown in FIG. 6, and as a non-limiting example, the first configuration F is a square configuration 210 and the second configuration is a circular shape or configuration 212. In embodiments, the first configuration F may include a hexagon. As shown in FIG. 7 as a non-limiting example, both the first and second configurations F and S have respective hexagonal configurations 214b and 214a. FIG. 7 further shows a nested hexagon configuration 214 in which the first configuration F is nested within the second configuration S. In embodiments, the first configuration F may include at least one of a square configuration 210 (FIG. 6) or a radial configuration 216 (FIG. 8). The radial configuration 216 may include a circular inner portion 218 as shown in FIG. 8. Further, the radial configuration 216 may include a plurality of outer linear portions 220 that are disposed around an outer perimeter of the circular inner portion 218 and extend away from the circular portion 218. In other embodiments, the first configuration F may include at least one of a circular configuration 212 (FIG. 6), a set of patterns (FIG. 9) including one or more trace arm formations, or a spiral configuration 222 (FIG. 10).

Referring once again to FIGS. 1 and 2A, in a block 106 of FIG. 1, the first substrate 200 and the second substrate 202 are bonded together using a high temperature bonding process to create a bond layer such as the bond layer 208 shown in FIG. 5. As an example and not a limitation, the high temperature bonding process may include one of a transient liquid phase soldering or a diffusion soldering. The at least one trace 204 (such as traces 204a and 204b of FIG. 2A) is incorporated into the bond layer 208 (as shown in FIG. 5) after the high temperature bonding process. The first configuration F forms one or more intermetallic bonds in the bond layer in block 106. The bond layer 208 is dispersed between aligned and adjacent surfaces 200S and 202S (as shown in FIG. 2A) of respective first and second substrates 200 and 202.

As a non-limiting example, the bond layer 208 may have a thickness in a range of from about 10 μm to 200 μm. In embodiments, the bond layer 208 may have a thickness that is at least about 10 microns (μm), at least about 20 microns, at least about 50 microns, at least about 100 microns, or even at least about 200 microns. In additional embodiments, the thickness of the bond layer 208 may be less than about 200 microns, less than about 100 microns, less than about 50 microns, less than about 20 microns, or even less than about 10 microns. As a non-limiting example, the thickness of any trace 204 is dictated by and approximately equal to or less than the thickness of the bond layer 208. For example, in embodiments, the thickness of at least one trace 204 may have a thickness in the range of from about 10 μm to 200 μm, or in the range of from about 5 μm to 150 μm, or in the range of from about 1 μm to 100 μm, or in the range of from about 1 μm to 10 μm. In embodiments, the thickness of the at least one trace 204 may be at least about 1 micron (μm), at least about 5 microns, at least about 10 microns, at least about 20 microns, at least about 50 microns, at least about 100 microns, or even at least about 200 microns. In additional embodiments, the thickness of the at least one trace 204 may be less than about 200 microns, less than about 150 microns, less than about 100 microns, less than about 50 microns, less than about 20 microns, or even less than about 10 microns.

It should now be understood that embodiments described herein are directed to exemplary methods for high temperature bonding of substrates to develop a strengthened bonding or bond layer between two bonded two substrates for power electronic applications. The bond layer is formed utilizing, in some embodiments, a process that incorporates one or more copper, nickel, and/or silver traces coated with tin as described herein. In some embodiments, the one or more traces may be three-dimensionally formed onto substrate surfaces to increase a surface area of the structures that create a bond layer after a high temperature bonding process so to create a stronger bond layer that bonds the substrates. The exemplary methods described herein result in a strengthened bond layer between two bonded substrates that may be used to bond semiconductor devices in power electronics applications and/or other suitable applications that bond two components together.

It is noted that the terms “substantially” and “about” and “approximately” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not he utilized in combination. It is therefore intended that the appended claims cover all such changes and modifications that are within the scope of the claimed subject matter.

What is claimed is:

1. A method for high temperature bonding of substrates, the method comprising:
providing a first substrate and a second substrate;
forming at least one trace onto one or more adjacent surfaces of the first and second substrates, wherein the at least one trace comprises at least a first configuration of a material having a high melting temperature. wherein the material comprises at least one or more chemical elements selected from a group consisting of nickel, silver, aluminum, and copper;
depositing at least a first amount of tin on a top surface of the at least one trace, wherein the top surface of the at least one trace is disposable between and facing at least one of the first substrate and the second substrate; and
bonding the first and second substrates together to create a bond layer using a high temperature bonding process, wherein the at least one trace is incorporated into the bond layer that is dispersed between aligned and adjacent surfaces of the first and second substrates, and wherein the first configuration forms one or more intermetallic bonds in the bond layer.

2. The method of claim 1, wherein forming the at least one trace comprises printing the first configuration of the at least one trace directly onto the one or more adjacent surfaces of the first and second substrates.

3. The method of claim 2, wherein printing comprises utilizing a 3D printing process.

4. The method of claim 1, wherein forming the at least one trace comprises etching the first configuration of the at least one trace onto the one or more surfaces of the first and second substrates.

5. The method of claim 4, wherein at least one of the first substrate or second substrate comprises a direct bonded copper substrate.

6. The method of claim 1, wherein the high temperature bonding process comprises one of a transient liquid phase soldering or a diffusion soldering.

7. The method of claim 1, wherein the first configuration comprises a hexagon.

8. The method of claim 1, wherein the first configuration comprises at least one of a spiral configuration or a circular configuration.

9. The method of claim 1, wherein:
the first configuration comprises at least one of a square configuration or a radial configuration; and
the radial configuration comprises a circular inner portion and a plurality of outer linear portions disposed around an outer perimeter of the circular inner portion and extending away from the circular inner portion.

10. The method of claim 1, wherein the bond layer has a thickness in a range of from about 10 μm to 200 μm.

11. The method of claim 1, wherein the material of the at least one trace comprises a weight percent in the range of from about 20% to about 40% and the tin comprises a respective weight percent in the range of from about 80% to about 60%.

12. The method of claim 1, wherein depositing the at least a first amount of tin on the top surface of the at least one trace comprises at least one of coating with tin, applying foils comprising tin, or applying a powder comprising tin.

13. The method of claim 12, further comprising depositing the at least a first amount of tin onto one or more adjacent surfaces of the first and second substrates via at least one of coating with tin, applying foils comprising tin, or applying the powder comprising tin.

14. The method of claim 1, wherein depositing the at least a first amount of tin on the top surface of the at least one trace comprises depositing a mesh tin pattern.

15. The method of claim 1, wherein:
forming the at least one trace onto one or more adjacent surfaces of the first and second substrates comprises depositing the at least one trace onto adjacent surfaces of the respective first and second substrates to form the first configuration on the first substrate surface and a second configuration on the second substrate surface, wherein:
the second configuration comprises a second configuration material having a high melting temperature; and
the second configuration material comprises at least one or more chemical elements selected from a group consisting of nickel, silver, aluminum, and copper;
depositing the at least a first amount of tin on the top surface of the at least one trace comprises depositing the at least a first amount of tin on a top surface of the first configuration and atop surface of the second configuration such that the at least a first amount of tin is disposed between the first and second substrates; and
the top surface of the first configuration faces the second substrate and the top surface of the second configuration faces the first substrate.

16. The method of claim 15, wherein the at least a first amount of tin is disposed between the top surfaces of the first configuration and the top surface of the second configuration and is spaced away from the first substrate surface and the second substrate surface, wherein the first configuration is substantially aligned with and disposed above the second configuration.

17. The method of claim 16, wherein:
the first configuration and the second configuration form a. substantially matching configuration; and
the substantially matching configuration is selected from a group consisting of hexagonal, circular, spiral, square, and radial, wherein the radial configuration comprises a circular inner portion and a plurality of outer linear portions disposed around an outer perimeter of the circular inner portion and extending away from the circular inner portion.

18. The method of claim 1, wherein:
the first substrate comprises at least one or more chemical elements selected from a group consisting of nickel, silver ink, and copper; and
the second substrate comprises at least one or more chemical elements selected from a group consisting of nickel, silver ink, and copper.

19. A bonding assembly comprising:
a first bonding assembly comprising:
a first substrate and a second substrate, wherein each of the first substrate and the second substrate comprises at least one or more chemical elements selected from a group consisting of nickel, silver, aluminum, and copper;
at least one trace formable onto one or more adjacent surfaces of the first and second substrates, wherein:
the at least one trace comprises at first configuration of a material having a high melting temperature; and
the material comprises at least one or more chemical elements selected from a group consisting of nickel, silver ink, and copper; and
at least a first amount of tin depositable on a top surface of the at least one trace, wherein:
the top surface is disposable between and facing at least one of the first substrate and the second substrate prior to bonding, and the at least one trace is incorporated into a bond layer after using a high temperature bonding process;
the high temperature bonding process comprises one of transient liquid phase soldering or a diffusion soldering;
the bond layer bonds the first and second substrates together and is dispersed between aligned and adjacent surfaces of the first and second substrates; and
the first configuration forms one or more intermetallic bonds in the bond layer.

20. The bonding assembly of claim 19, wherein:
the first configuration comprises one or more shapes; and
at least one of the one or more shapes is selected from a group consisting of hexagonal, circular spiral, square, and radial;
wherein the radial shape comprises a circular inner portion and a plurality of outer linear portions disposed around an outer perimeter of the circular inner portion and extending away from the circular inner portion.
